(19) United States
(12) Patent Application Publication
(10) Pub. No.: US 2024/0151887 A1
(43) Pub. Date: May 9, 2024

(54) RETARDATION PLATE AND OPTICAL ELEMENT

(71) Applicant: AGC Inc., Tokyo (JP)

(72) Inventors: Kenta SEKIKAWA, Fukushima (JP); Hiromichi NAGAYAMA, Fukushima (JP)

(73) Assignee: AGC Inc., Tokyo (JP)

(21) Appl. No.: 18/530,326

(22) Filed: Dec. 6, 2023

Related U.S. Application Data
(63) Continuation of application No. PCT/JP2022/024736, filed on Jun. 21, 2022.

(30) Foreign Application Priority Data
Jun. 29, 2021 (JP) 2021-107798

(51) Int. Cl. G02B 5/30; C09K 19/38

(52) U.S. Cl. CPC G02B 5/3016; C09K 19/3809

(57) ABSTRACT

A retardation plate includes a transparent substrate, and a liquid crystal layer formed over the transparent substrate, wherein, when a tensile test is performed by pulling the retardation plate in a predetermined direction at a glass-transition temperature of the transparent substrate, a tensile elongation C defined by an equation of C=(B−A)/A×100 is 12% or more, where A is an initial size of the retardation plate in the predetermined direction, and B is a size of the retardation plate in the predetermined direction when a crack penetrating the liquid crystal layer in a thickness direction occurs over a length of 1 mm or more on a surface of the liquid crystal layer.

### CROSS-REFERENCE TO RELATED APPLICATION

The present application is a continuation application filed under 35 U.S.C. 111 (a) claiming benefit under 35 U.S.C. 120 and 365 (c) of PCT International Application No. PCT/JP2022/024736 filed on Jun. 21, 2022 and designating the U.S., which claims priority to Japanese Patent Application No. 2021-107798 filed on Jun. 29, 2021. The entire contents of the foregoing applications are incorporated herein by reference.

### BACKGROUND OF THE INVENTION

### 1. Field of the Invention

The present disclosure relates to a retardation plate and an optical element.

### 2. Description of the Related Art

In the method of manufacturing an optical element described in Patent Document 1, (A) an alignment layer having a fine groove structure is formed, (B) a coating material exhibiting a liquid crystal phase is laminated on the alignment layer, and (C) the coating material layer is solidified to fix the alignment of the liquid crystal phase.

In the liquid crystal device described in Patent Document 2, liquid crystal molecules are interposed between a first substrate and a second substrate, and light waves are modulated by birefringence of the liquid crystal. The first substrate or the second substrate is provided with a grating structure having a pitch shorter than the wavelength of the light wave. The grating structure is formed by a nano-imprint method, controls the alignment direction of liquid crystal molecules, and controls the phase of light waves passing through the liquid crystal.

The method of manufacturing a liquid crystal alignment film described in Patent Document 3 includes a step of injecting a liquid crystal material onto a non-flat surface of an alignment film to form a liquid crystal layer. The method of manufacturing the alignment film includes (A) transferring an uneven pattern of a mold to a layer to be transferred, (B) forming a titanium dioxide layer on the uneven pattern, (C) deforming the titanium dioxide layer into a curved surface, and (D) etching the titanium dioxide layer deformed into the curved surface to form a fine uneven pattern on the curved surface. A liquid crystal material is injected onto the uneven pattern. Patent Document 4 describes a photo-curable composition.

### CITATION LIST

### Patent Document

[Patent Document 1] Japanese Translation of PCT International Application Publication No. 2005-516236

[Patent Document 2] Japanese Patent Application Laid-Open No. 2013-7781

[Patent Document 3] Japanese Translation of PCT International Application Publication No. 2016-509966

[Patent Document 4] Japanese Patent No. 5978761

### SUMMARY OF THE INVENTION

### Problems to be Solved by the Invention

To solve the problem that a conventional liquid crystal layer is stretched and cracked when the conventional liquid crystal layer is bent or stored under high-temperature and high-humidity. The crack penetrates the liquid crystal layer in the thickness direction, causes a local decrease in retardation, and increases a variation in color tone.

An aspect of the present disclosure provides a technique for suppressing occurrence of cracks in a liquid crystal layer during bending or during storage under high-temperature and high-humidity.

### Means for Solving the Problem

A retardation plate according to a first aspect of the present disclosure includes a transparent substrate, and a liquid crystal layer formed over the transparent substrate, wherein, when a tensile test is performed by pulling the retardation plate in a predetermined direction at a glass-transition temperature of the transparent substrate, a tensile elongation C defined by an equation of C=(B−A)/A×100 is 12% or more, where A is an initial size of the retardation plate in the predetermined direction, and B is a size of the retardation plate in the predetermined direction when a crack penetrating the liquid crystal layer in a thickness direction occurs over a length of 1 mm or more on a surface of the liquid crystal layer.

An optical element according to a second aspect of the present disclosure includes a three-dimensional structure having a curved surface, and a retardation plate curved along the curved surface of the three-dimensional structure, wherein the retardation plate includes a liquid crystal layer containing a compound having liquid crystallinity, and wherein a concentration of a sulfur element in the liquid crystal layer is 0.6% by mass to 3.5% by mass.

An optical element according to a third aspect of the present disclosure includes a three-dimensional structure having a curved surface, and a retardation plate curved along the curved surface of the three-dimensional structure, wherein the retardation plate includes a liquid crystal layer containing a compound having liquid crystallinity, and wherein the liquid crystal layer contains the compound having a structure represented by a following formula (1), and n in the following formula (1) is 3 to 15.

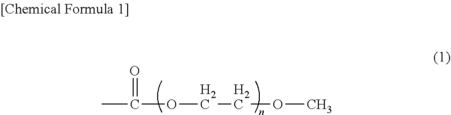

### Effects of the Invention

According to one aspect of the present disclosure, occurrence of cracks in a liquid crystal layer during bending or during storage under high-temperature and high-humidity can be suppressed.

### BRIEF DESCRIPTION OF THE DRAWINGS

FIG. 1A is a cross-sectional view illustrating a retardation plate and a three-dimensional structure having a curved surface according to one embodiment;

FIG. 1B is a cross-sectional view of an optical element formed by bonding the retardation plate and the three-dimensional structure having a curved surface, illustrated in FIG. 1A;

FIG. 1C is a plan view of the optical element illustrated in FIG. 1B;

FIG. 2A is a cross-sectional view illustrating an optical element according to a first modification;

FIG. 2B is a cross-sectional view illustrating an optical element according to a second modification;

FIG. 2C is a cross-sectional view illustrating an optical element according to a third modification;

FIG. 3A is a perspective view illustrating an example of a transparent substrate and an alignment layer;

FIG. 3B is a perspective view illustrating an example of liquid crystal molecules aligned by the alignment layer illustrated in FIG. 3A;

FIG. 4 is a cross-sectional view illustrating an example of bending of the retardation plate;

FIG. 5 is a cross-sectional view illustrating an example of a reliability test of the optical element;

FIG. 6 is a plan view illustrating an example of cracks generated in a conventional liquid crystal layer;

FIG. 7 is a view illustrating an example of a first test piece;

FIG. 8 is a view illustrating an example of a second test piece; and

FIG. 9 is a cross-sectional view illustrating an example of a retardation plate having a second liquid crystal layer.

### DETAILED DESCRIPTION OF THE PREFERRED EMBODIMENTS

Hereinafter, embodiments of the present disclosure will be described with reference to the drawings. In the drawings, the same or corresponding components are denoted by the same reference numerals, and description thereof may be omitted. In addition, in the specification, “to” indicating a numerical range means that numerical values described before and after the “to” are included as a lower limit value and an upper limit value.

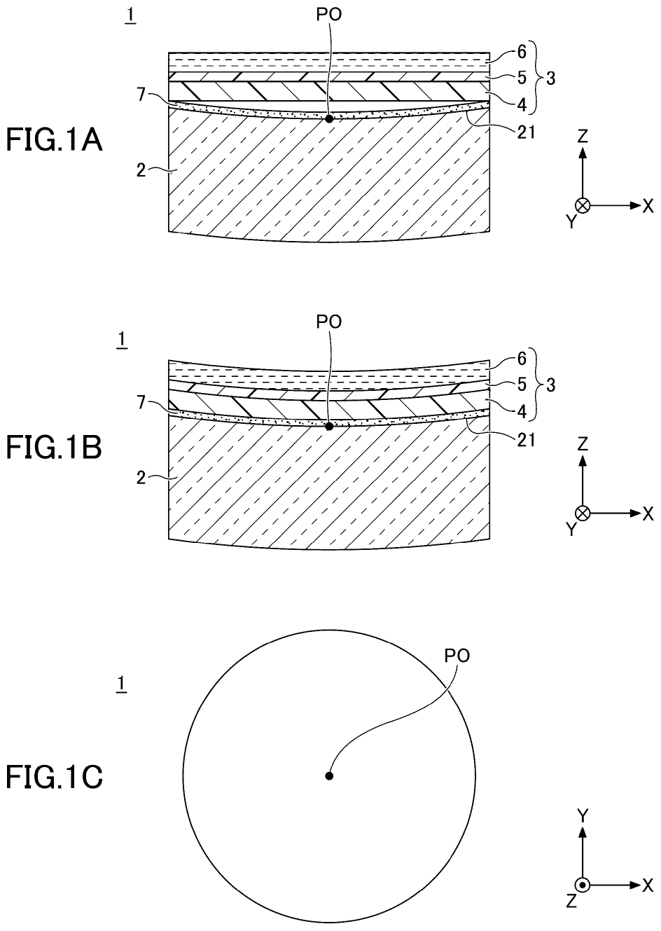

An optical element 1 according to an embodiment will be described with reference to FIG. 1A to FIG. 3B. The optical element 1 is desired to have a curved surface from the viewpoint of performance. For example, the optical element 1 includes a three-dimensional structure 2 having a curved surface 21. Examples of the three-dimensional structure 2 include a lens, a prism, and a mirror. When the three-dimensional structure 2 is a lens, the lens may be a spherical lens or an aspherical lens. When the three-dimensional structure 2 is a lens, the lens may be any of a biconcave lens, a plano-concave lens, a concave meniscus lens, a biconvex lens, a plano-convex lens, and a convex meniscus lens.

The three-dimensional structure 2 has a curved surface 21. The curved surface 21 has a curvature radius of, for example, 10 mm to 100 mm over the entire surface or a part thereof. The curvature radius of the curved surface 21 is preferably 20 mm to 80 mm, and more preferably 50 mm to 70 mm.

The curved surface 21 is, for example, a concave surface as illustrated in FIGS. 1A and 1B. The concave surface is a curved surface in which a surface at a center of gravity P0 is concave from a periphery. In both the cross-section perpendicular to the X-axis direction and the cross-section perpendicular to the Y-axis direction, the center of gravity P0 of the concave surface is concave from the periphery of the concave surface. The X-axis direction, the Y-axis direction, and the Z-axis direction are perpendicular to each other. The Z-axis direction is a direction normal to the concave surface at the center of gravity P0. The XY plane is parallel to a tangential plane at the center of gravity P0 of the concave surface.

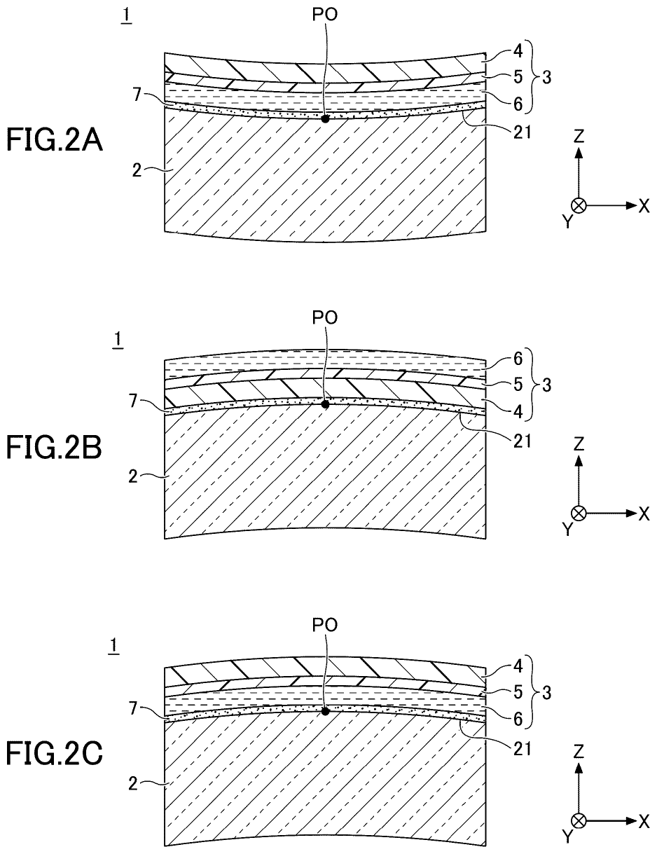

Although the curved surface 21 is a concave surface in the present embodiment, the curved surface 21 may be a convex surface as illustrated in FIGS. 2B and 2C. The convex surface is a curved surface in which the surface at the center of gravity P0 is protruded from the periphery. In both the cross-section perpendicular to the X-axis direction and the cross-section perpendicular to the Y-axis direction, the center of gravity P0 of the convex surface is protruded from the periphery of the convex surface.

The outer shape of the three-dimensional structure 2 is not limited to a circular shape illustrated in FIG. 1C, and may be, for example, an elliptical shape, a polygonal shape (including a quadrangular shape), and the like.

The material of the three-dimensional structure 2 may be resin or glass. When the three-dimensional structure 2 is a resin lens, the resin of the resin lens is, for example, a polycarbonate, polyimide, polyacrylate, or cyclic olefin. In the case where the three-dimensional structure 2 is a glass lens, the glass of the glass lens is, for example, BK7 or synthetic quartz.

The optical element 1 includes a retardation plate 3. The retardation plate 3 is bent along the curved surface 21 of the three-dimensional structure 2. The retardation plate 3 includes, for example, a transparent substrate 4, an alignment layer 5 formed over the transparent substrate 4, and a liquid crystal layer 6 formed over the alignment layer 5.

The retardation plate 3 has a slow axis and a fast axis. When viewed in the Z-axis direction, the slow axis is in the X-axis direction and the fast axis is in the Y-axis direction. The refractive index is the greatest in the slow axis direction, and the refractive index is the smallest in the fast axis direction.

The retardation plate 3 is, for example, a ¼ wavelength plate. The ¼ wavelength plate and a linearly polarizing plate (not illustrated) may be used in combination. The absorption axis of the linearly polarizing plate and the slow axis of the ¼ wavelength plate are arranged so as to be shifted from each other by 45°. The linearly polarizing plate and the ¼ wavelength plate constitute a circularly polarizing plate.

The linearly polarizing plate may be disposed on the side opposite to the three-dimensional structure 2 with respect to the retardation plate 3, may be disposed between the retardation plate 3 and the three-dimensional structure 2, or may be disposed on the side opposite to the retardation plate 3 with respect to the three-dimensional structure 2.

The retardation plate 3 includes, for example, the transparent substrate 4, the alignment layer 5, and the liquid crystal layer 6 in this order from the three-dimensional structure 2 side as illustrated in FIG. 1B. As illustrated in FIGS. 2A and 2C, the retardation plate 3 may include the liquid crystal layer 6, the alignment layer 5, and the transparent substrate 4 in this order from the three-dimensional structure 2 side.

The transparent substrate 4 is formed of, for example, a glass substrate or a resin substrate. The glass substrate or the resin substrate may be configured to have a reflection function or an absorption function with respect to any one or two or more of infrared light, visible light, and ultraviolet light and transmit light in a specific wavelength band. The transparent substrate 4 may have a single-layer structure of a single substrate, or may have a multi-layer structure in which a film providing a reflection function or an absorption function to a main substrate (glass substrate or resin substrate) is laminated, and transmits light in a specific wavelength band. A film that provides an antifouling function or the like, in addition to the reflection function and the absorption function, may be laminated in the transparent substrate 4.

For example, the transparent substrate 4 may further include a resin film or an inorganic film in addition to the glass substrate or the resin substrate. The resin film is, for example, a film having a function of a color tone correction filter, a base film containing a silane coupling agent, or the like, or an antifouling film. The resin film is formed by, for example, screen printing, vapor deposition, a spray coating, a spin coating, or the like. The inorganic film is, for example, a metal oxide film having a function of an optical interference film (antireflection or wavelength selection filter). The inorganic film is formed by, for example, a sputtering method, vapor deposition, a CVD method, or the like.

The transparent substrate 4 is preferably a resin substrate from the viewpoint of bending processability. Specific examples of the resin of the resin substrate include polymethyl methacrylate (PMMA), triacetyl cellulose (TAC), cycloolefin polymer (COP), cycloolefin copolymer (COC), polyethylene terephthalate (PET), and polycarbonate (PC).

A retardation of the transparent substrate 4 is, for example, 5 nm or less, preferably 3 nm or less. The retardation of the transparent substrate 4 is preferably as small as possible from the viewpoint of reducing variation in color tone, and may be zero. The retardation of the transparent substrate 4 is measured by, for example, a parallel Nicol rotation method.

The glass-transition temperature Tg_f of the transparent substrate 4 is, for example, 80° C. to 200° C., preferably 90° C. to 180° C., and more preferably 100° C. to 160° C. When the glass-transition temperature Tg_f is within the above range, good bending processability is obtained. The glass-transition temperature of the transparent substrate 4 is measured by, for example, thermomechanical analysis (TMA).

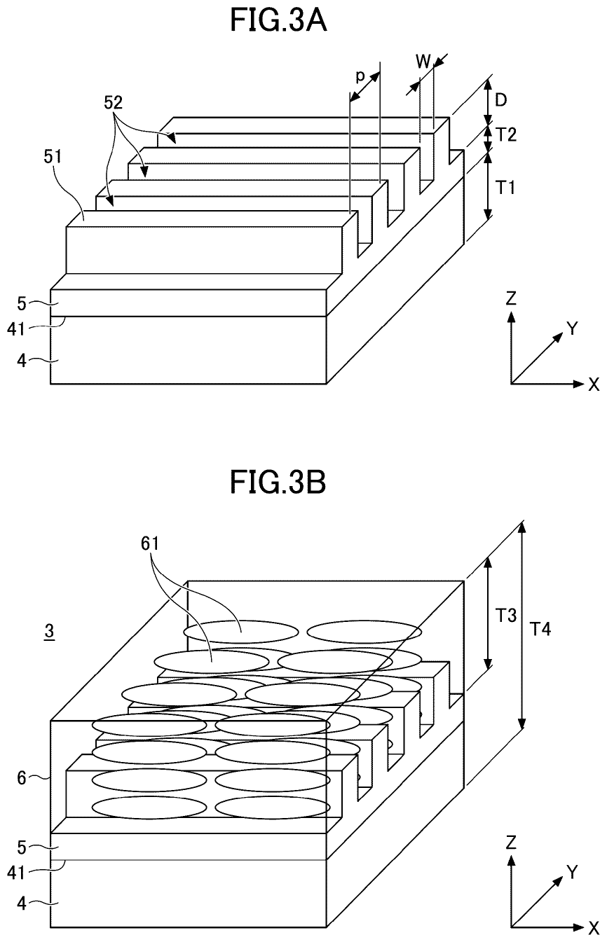

The thickness T1 of the transparent substrate 4 (see FIG. 3A) is, for example, 0.01 mm to 0.3 mm, preferably 0.02 mm to 0.1 mm, more preferably 0.03 mm to 0.09 mm. When the thickness T1 is within the above range, both bending processability and handling property can be achieved.

The alignment layer 5 aligns liquid crystal molecules of the liquid crystal layer 6. On a surface 51 of the alignment layer 5 in contact with the liquid crystal layer 6, for example, a plurality of grooves 52 parallel to each other are formed. The plurality of grooves 52 are formed in a stripe pattern, for example. When viewed in the Z-axis direction, the longitudinal direction of the groove 52 is the X-axis direction, and the width direction of the groove 52 is the Y-axis direction.

The parallelism of the grooves 52 is, for example, 0° to 5°, and preferably 0° to 1°. The parallelism of the grooves 52 is a maximum value of an angle formed by two adjacent grooves 52 when viewed in the Z-axis direction. The closer to 0° the angle formed by two adjacent grooves 52 is, the better the parallelism is.

The depth D of the groove 52 is, for example, from 3 nm to 500 nm, preferably from 5 nm to 300 nm, and more preferably from 10 nm to 150 nm. When D is 3 nm or more, the alignment regulating force is large and the liquid crystal molecules are easily aligned. On the other hand, when D is 500 nm or less, the transferability of the uneven pattern of the mold is good. When D is 500 nm or less, diffracted light is less likely to be generated.

The pitch p of the grooves 52 is, for example, from 10 nm to 600 nm, preferably from 50 nm to 300 nm, and more preferably from 80 nm to 200 nm. When p is 600 nm or less, the alignment regulating force is large and the liquid crystal molecules are easily aligned. When p is 300 nm or less, diffracted light is less likely to be generated. On the other hand, when p is 10 nm or more, the uneven pattern of the mold is easily formed.

The opening width W of the groove 52 is, for example, from 5 nm to 500 nm, preferably from 20 nm to 200 nm, and more preferably from 30 nm to 150 nm. The difference between the pitch p and the opening width W (p−W:p>W) is an interval between the grooves 52.

A cross-section perpendicular to the longitudinal direction (X-axis direction) of the groove 52 has a rectangular shape in FIGS. 3A and 3B, but may be a triangular shape. The width of the groove 52 having a triangular cross-section increases as the depth decreases. In this case, the mold used in the imprint method can be easily peeled.

The alignment layer 5 is a copolymer of an energy curable composition. The energy curable composition is a photocurable composition or a thermally curable composition. In particular, a photocurable composition is preferable from the viewpoint of excellent processability, heat resistance, and durability. The photocurable composition is, for example, a composition containing a monomer, a photopolymerization initiator, a solvent, and if necessary, an additive (for example, a surfactant, a polymerization inhibitor, an antioxidant, an ultraviolet absorber, a light stabilizer, or an antifoaming agent). As the photocurable composition, for example, a composition described in paragraphs 0028 to 0060 of Japanese Patent No. 5978761 is used.

The alignment layer 5 is formed by, for example, the imprint method. In the imprint method, the energy curable composition is sandwiched between the transparent substrate 4 and the mold, the uneven pattern of the mold is transferred to the energy curable composition, and the energy curable composition is cured. When the imprint method is used, the size and shape of the grooves 52 can be controlled with high accuracy, and mixing of foreign matter can be reduced.

The energy curable composition may be applied onto the transparent substrate 4 or may be applied onto the mold. Examples of the coating method include spin coating, bar coating, dip coating, casting, spray coating, bead coating, wire bar coating, blade coating, roller coating, curtain coating, slit die coating, gravure coating, slit reverse coating, Micro Gravure™ coating, comma coating, and the like.

The thickness T2 of the alignment layer 5 (see FIG. 3A) is, for example, 1 nm to 20 μm, preferably 50 nm to 10 μm, and more preferably 100 nm to 5 μm. The thickness T2 of the alignment layer 5 is measured in the direction normal to the surface of the transparent substrate 4, on which the alignment 5 is formed, at each point on the surface 41. When the alignment layer 5 has the grooves 52, the thickness T2 of the alignment layer 5 in the present specification is a distance between a bottom of the grooves 52 and the surface 41 of the transparent substrate 4. When the thickness T2 of the alignment layer 5 is 20 μm or less, processability is good.

The glass-transition temperature Tg_al of the alignment layer 5 is, for example, 40° C. to 200° C., preferably 60° C. to 180° C., and more preferably 80° C. to 150° C. When the Tg_al is within the above range, good bending processability is obtained. The glass-transition temperature of the alignment layer 5 is measured by, for example, TMA.

The alignment layer 5 is not limited to a layer including a fine parallel groove structure. The alignment layer 5 may be subjected to the following treatment. Examples of the treatment applied to the alignment layer 5 include rubbing treatment of polyimide, photodecomposition of a silane coupling agent or polyimide by polarized UV irradiation, photodimerization or photoisomerization by polarized UV irradiation, flow alignment treatment by shear force, and alignment treatment by oblique deposition of an inorganic substance. Multiple treatments may be used in combination.

The alignment layer 5 is optional and may be omitted. In this case, the transparent substrate 4 may be subjected to a treatment for aligning the liquid crystal molecules of the liquid crystal layer 6. The treatment is, for example, an alignment treatment by rubbing of polyimide, photodecomposition of a silane coupling agent or polyimide by polarized UV light, photodimerization or photoisomerization by being irradiated with polarized UV light, flow alignment treatment by shear force, or oblique vapor deposition of an inorganic substance.

The liquid crystal layer 6 has a slow axis and a fast axis. The liquid crystal layer 6 has a slow axis and a fast axis. The retardation Rd is a product of a difference Δn between the refractive index ne of the slow axis and the refractive index no of the fast axis (Δn=ne−no) and a size d of the liquid crystal layer 6 in the Z-axis direction. That is, the retardation Rd is obtained from a relation Rd=Δn×d.

As illustrated in FIG. 3B, the liquid crystal layer 6 includes a plurality of liquid crystal molecules 61 aligned in parallel to each other according to the alignment layer 5. When viewed in the Z-axis direction, the long-axis direction of the liquid crystal molecules 61 is parallel to the X-axis direction, and the short-axis direction of the liquid crystal molecules 61 is parallel to the Y-axis direction. The liquid crystal molecules 61 are rod-shaped liquid crystals in the present embodiment, but may be discotic liquid crystals. The liquid crystal molecules 61 may be twisted.

The liquid crystal layer 6 is formed by applying and drying a liquid crystal composition. The liquid crystal composition is, for example, a photocurable polymer liquid crystal containing an acrylic group or a methacrylic group. The liquid crystal composition may contain a component that does not exhibit a liquid crystal phase by itself. It is sufficient that a liquid crystal phase is generated by polymerization. Examples of the component that does not exhibit a liquid crystal phase include monofunctional (meth)acrylates, bifunctional (meth)acrylates, and (meth)acrylates having three or more functional groups. The polymerizable liquid crystal composition may contain a photocurable monomer. The polymerizable liquid crystal composition may contain an additive. Examples of the additive include a polymerization initiator, a surfactant, a chiral agent, a polymerization inhibitor, an ultraviolet absorber, an antioxidant, a light stabilizer, an antifoaming agent, a dichroic dye, or the like. A plurality of types of additives may be used in combination.

A known method may be used for applying the liquid crystal composition. Examples of the coating method of the liquid crystal composition include a spin coating method, a bar coating method, an extrusion coating method, a direct gravure coating method, a reverse gravure coating method, a die coating method, or the like. A solvent of the liquid crystal composition is removed by heating after coating.

The solvent of the liquid crystal composition is, for example, an organic solvent. Examples of the organic solvents include alcohols such as isopropyl alcohol; amides such as N,N-dimethylformamide; sulfoxides such as dimethyl sulfoxide; hydrocarbons such as benzene or hexane; esters such as methyl acetate, ethyl acetate, butyl acetate, or propylene glycol monoethyl ether acetate; ketones such as acetone or methyl ethyl ketone; or ethers such as tetrahydrofuran or 1,2-dimethoxyethane. Two or more types of the organic solvents may be used in combination. The liquid crystal layer 6 may be formed by a vapor deposition method or a vacuum injection method without using a solvent.

The liquid crystal composition to be used may have a positive or negative wavelength dispersion of the Δn value after curing.

The liquid crystal composition contains, for example, compounds represented by the following formulae (a-1) to (a-13) as the polymerizable compound.

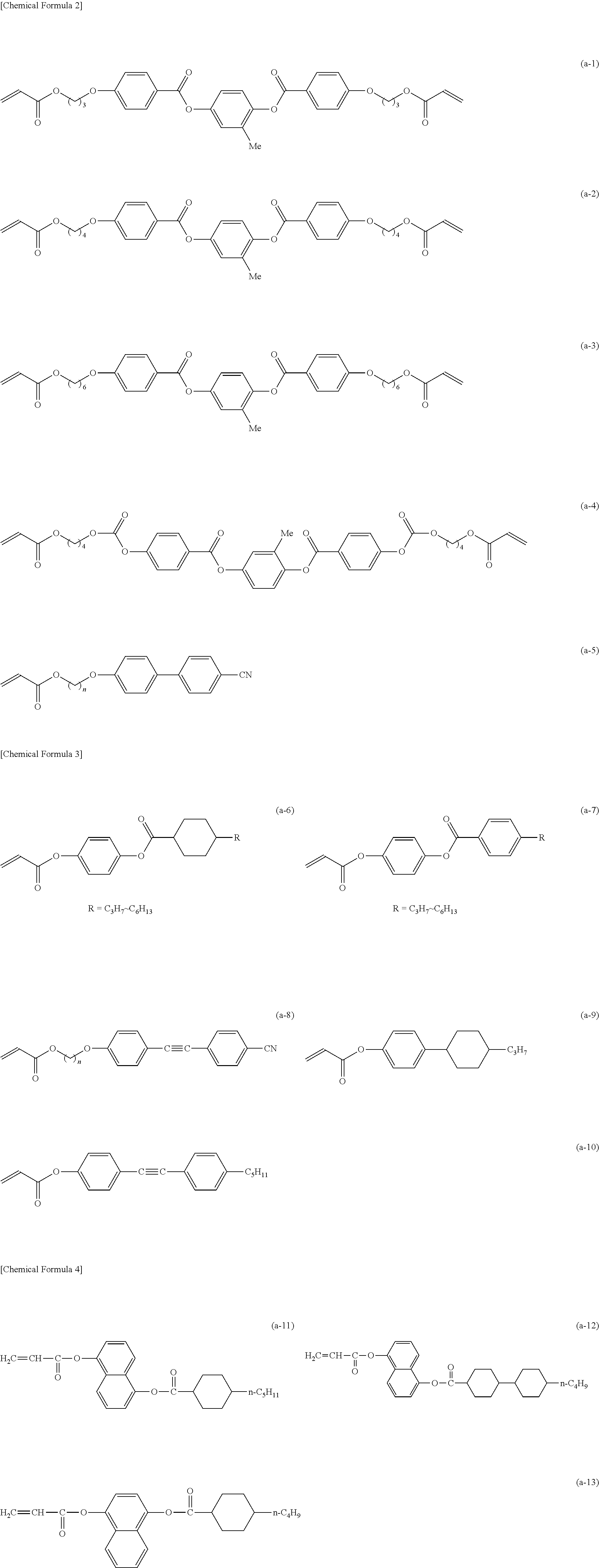

In the formulae (a-5) and (a-8), n is an integer of 3 to 6. In the above formulae (a-6) and (a-7), R is an alkyl group having 3 to 6 carbon atoms.

The thickness T3 of the liquid crystal layer 6 (see FIG. 3B) is determined based on the wavelength of light, a retardation, and the difference Δn (Δn=ne−no). For example, when the wavelength of the light is 543 nm and the retardation is a ¼ wavelength length, the retardation Rd is 136 nm. When the retardation Rd is 136 nm and the difference Δn is 0.1, the thickness T3 of the liquid crystal layer 6 is 1360 nm.

As described above, the thickness T3 of the liquid crystal layer 6 is determined based on the wavelengths of light, the retardation, and the difference Δn. The thickness T3 is not particularly limited, and is, for example, 0.3 μm to 30 μm, preferably 0.5 μm to 20 μm, and more preferably 0.8 μm to 10 μm. When the thickness T3 is 0.3 μm or more, a desired retardation is easily obtained. When the thickness T3 is 30 μm or less, the liquid crystal molecules 61 are easily aligned.

The liquid crystal layer 6 is not limited to a ¼ wavelength plate, and may be a ½ wavelength plate or the like. The liquid crystal layer 6 is not limited to a retardation layer that shifts the phase between two linearly polarized light components orthogonal to each other, and may be a compensation layer. The compensation layer, for example, corrects the retardation occurring at different viewing angles of the liquid crystal display, and improves the screen contrast within a predetermined viewing angle.

The thickness T3 of the liquid crystal layer 6 is measured in the direction normal to the surface of the transparent substrate 4, over which the liquid crystal layer 6 is formed, at each point on the surface 41. When the alignment layer 5 has the grooves 52, in the present specification, the thickness T3 of the liquid crystal layer 6 is a distance between the bottom of the grooves 52 and a surface of the liquid crystal layer 6 on the side opposite to the alignment layer 5.

The glass-transition temperature Tg_a of the liquid crystal layer 6 is, for example, 50° C. to 200° C., and preferably 80° C. to 180° C. When the glass-transition temperature Tg_a is within the above range, good bending processability is obtained. The glass-transition temperature Tg_a of the liquid crystal layer 6 is measured by, for example, TMA.

The thickness T4 of the retardation plate 3 is not particularly limited. The thickness T4 is, for example, 0.011 mm to 0.301 mm, preferably 0.021 mm to 0.101 mm, and more preferably 0.031 mm to 0.091 mm. The thickness T4 of the retardation plate 3 is measured in the direction normal to the surface of the transparent substrate 4, over which the liquid crystal layer 6 is formed, at each point.

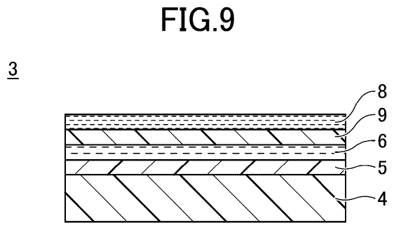

As illustrated in FIG. 9, the retardation plate 3 may include a second liquid crystal layer 8 having a slow axis direction different from that of the liquid crystal layer 6, and may further include a second alignment layer 9 for aligning liquid crystal molecules of the second liquid crystal layer 8. That is, the retardation plate 3 may be a broadband retardation plate.

The second liquid crystal layer 8 is configured in the same manner as the liquid crystal layer 6 and has the same material as the liquid crystal layer 6, but may have a different material from the liquid crystal layer 6. The second alignment layer 9 is configured in the same manner as the alignment layer 5 and has the same material as the alignment layer 5, but may have a different material from the alignment layer 5. The order of the second liquid crystal layer 8 and the liquid crystal layer 6 may be reversed, and the second liquid crystal layer 8 may be disposed between the transparent substrate 4 and the liquid crystal layer 6.

Although not illustrated, the retardation plate 3 may include a third liquid crystal layer having a slow axis direction different from that of the liquid crystal layer 6 and the second liquid crystal layer 8, and may further include a third alignment layer that aligns liquid crystal molecules of the third liquid crystal layer. The number of liquid crystal layers included in the retardation plate 3 may be four or more.

The retardation plate 3 is bent and bonded to the three-dimensional structure 2. The bonding layer 7 is formed of, for example, optically-clear adhesive (OCA), liquid adhesive (OSA), polyvinyl butyral (PVB), ethylene vinyl acetate (EVA), cycloolefin polymer (COP) or thermoplastic polyurethane (TPU).

The retardation of the bonding layer 7 is, for example, 5 nm or less, and preferably 3 nm or less. The retardation of the bonding layer 7 is preferably as small as possible from the viewpoint of reducing variation in color tone, and may be zero. The retardation of the bonding layer 7 is measured by, for example, a parallel Nicol rotation method.

The glass-transition temperature of the bonding layer 7 is, for example, −60° C. to 100° C., and preferably −40° C. to 50° C. When the glass-transition temperature of the bonding layer 7 is within the above-described range, both bending processability and shape followability can be achieved. The glass-transition temperature of the bonding layer 7 is measured by, for example, TMA.

The thickness of the bonding layer 7 is, for example, 0.001 mm to 0.1 mm, and preferably 0.005 mm to 0.05 mm. When the thickness of the bonding layer 7 is within the above-described range, both bending processability and shape followability can be achieved. The thickness of the bonding layer 7 is measured in a direction normal to the curved surface 21 of the three-dimensional structure 2 at each point on the curved surface 21.

The retardation plate 3 and the three-dimensional structure 2 are bonded while being heated. The heating temperature is set based on the glass-transition temperature Tg_f of the transparent substrate 4, and is set in a range of, for example, Tg_f−10° C. or higher and Tg_f+30° C. or lower. The bonding of the retardation plate 3 and the three-dimensional structure 2 may be performed in a vacuum.

Alternatively, the three-dimensional structure 2 may be injection-molded after the retardation plate 3 is disposed in a mold for injection molding and the retardation plate 3 is bent. When the three-dimensional structure 2 and the retardation plate 3 are integrated by in-mold molding, the bonding layer 7 is not necessary.

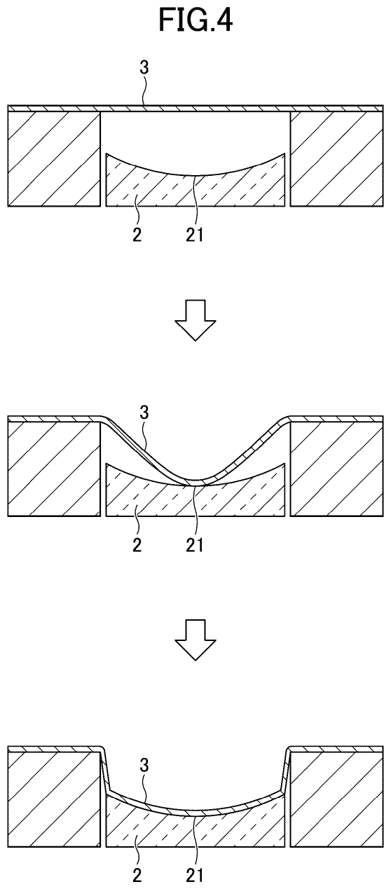

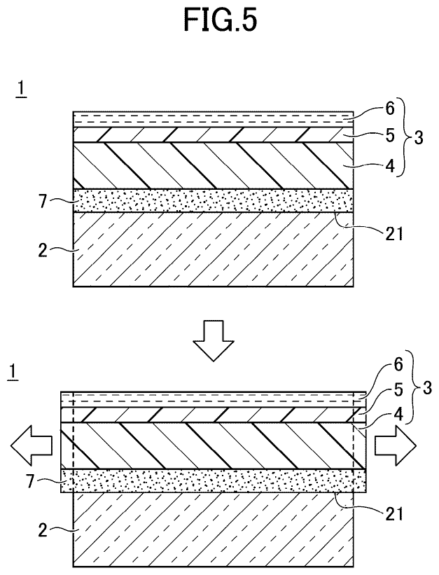

Next, an example of the bending process of the retardation plate 3 will be described with reference to FIG. 4. As illustrated in FIG. 4, the retardation plate 3 first comes into contact with the center of the curved surface 21 of the three-dimensional structure 2, and then gradually comes into contact with the curved surface 21 from the center toward the periphery. Thus, the air existing between the retardation plate 3 and the three-dimensional structure 2 can be released from the center toward the periphery, and the inclusion of the air can be suppressed. The retardation plate 3 is first radially and uniformly stretched so as to come into contact with the center of the curved surface 21 of the three-dimensional structure 2.

Next, an example of a reliability test of the optical element 1 will be described with reference to FIG. 5. As a reliability test of the optical element 1, a high-temperature and high-humidity test is usually used. In the high-temperature and high-humidity test, the optical element 1 is stored in an environment at a temperature of 65° C. and a relative humidity of 90% for 500 hours, and the appearance of the optical element 1 is inspected. Under high-temperature and high-humidity, at least one of thermal expansion and water absorption occurs, the transparent substrate 4 is stretched, and the liquid crystal layer 6 is stretched so as to follow the transparent substrate 4.

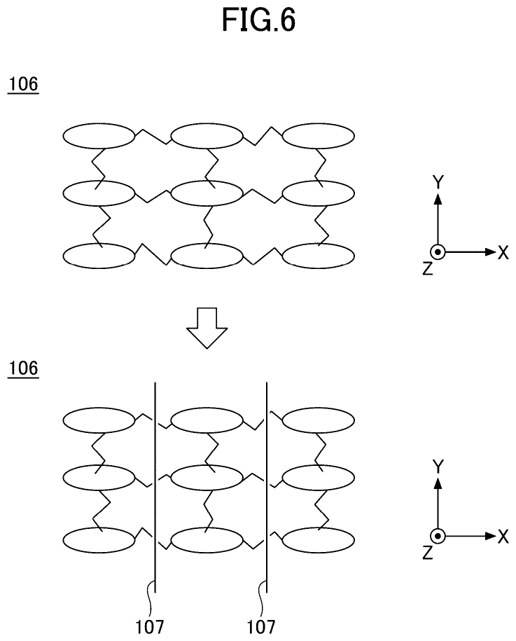

As illustrated in FIGS. 4 and 5, the liquid crystal layer 6 is stretched during bending or during storage under high-temperature and high-humidity. As illustrated in FIG. 6, in a conventional liquid crystal layer 106, the elongation margin in the slow axis direction (X-axis direction) is small, and a linear crack 107 may occur in a direction (fast axis direction (Y-axis direction)) perpendicular to the slow axis direction. The crack 107 penetrates the liquid crystal layer 106 in the thickness direction, causes a local decrease in retardation, and increases a variation in color tone. The liquid crystal layer 6 contains, for example, a second compound having a sulfide bond represented by the following formula (2) or a disulfide bond represented by the following formula (3) for the purpose of increasing the elongation margin in the slow axis direction. The second compound may have both a sulfide bond and a disulfide bond. The second liquid crystal layer 8 and the third liquid crystal layer may be the same as the liquid crystal layer 6.

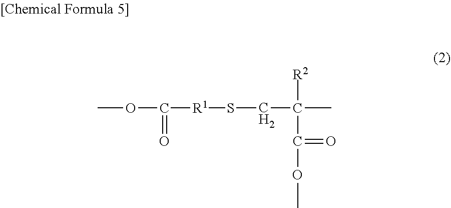

In the formula (2), R¹ represents a linear or branched alkylene group having 1 to 5 carbon atoms. R² represents hydrogen (H) or a methyl group.

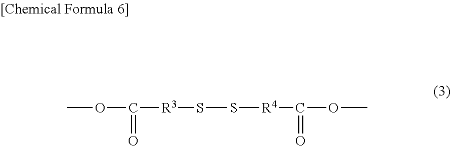

In the formula (3), R³ and R⁴ each represent a linear or branched alkylene group having 1 to 5 carbon atoms.

The sulfide bond and the disulfide bond are excellent in flexibility and can increase an elongation margin in the slow axis direction of the liquid crystal layer 6. The total amount of the sulfide bond and the disulfide bond is represented by the concentration C1 of the sulfur element (S) in the liquid crystal layer 6.

In the liquid crystal layer 6, the concentration C1 of the sulfur element is, for example, 0.6% by mass to 3.5% by mass. When the concentration C1 is 0.6% by mass or more, the flexibility of the liquid crystal layer 6 is good, the elongation margin of the liquid crystal layer 6 in the slow axis direction is large, and the occurrence of cracks in the liquid crystal layer 6 can be suppressed. When the concentration C1 is 3.5% by mass or less, the liquid crystal molecules of the liquid crystal layer 6 are easily aligned. The concentration C1 is preferably 0.8% by mass to 3.3% by mass, and more preferably 1% by mass to 3% by mass.

In the case where the liquid crystal layer 6 contains the second compound, the liquid crystal composition contains a monomer containing a thiol group (SH group). In the liquid crystal composition, a content C2 of the thiol group-containing monomer is, for example, 3% by mass to 15% by mass. When the content of C2 is 3% by mass or more, occurrence of cracks in the liquid crystal layer 6 can be suppressed. When the content C2 is 15% by mass or less, the liquid crystal molecules of the liquid crystal layer 6 are easily aligned. The content C2 is preferably 5% by mass to 10% by mass.

The thiol group-containing monomer may be a primary thiol group or a secondary thiol group, and is a compound having 1 to 6 thiol groups in the molecule. A polyfunctional secondary thiol which can prevent a thermal addition reaction to a monomer by steric hindrance around a thiol group and suppress gelation during storage is preferable. The polyfunctional secondary thiol includes, for example, pentaerythritol tetrakis(3-mercaptobutyrate), 1,4-bis (3-mercaptobutyryloxy)butane, 1,3,5-tris (3-mercaptobutyryloxyethyl)-1,3,5-triazine-2,4,6(1H,2H,5H)-trione and the like, and from the viewpoint of not appreciably disturbing the alignment of the liquid crystal, a bifunctional or trifunctional thiol compound is preferable, and a bifunctional thiol compound is particularly preferable.

Examples of commercially available thiol group-containing monomers include Karenz MT BD1, Karenz MT PE1, and Karenz MT NR1 (manufactured by Showa Denko Co., Ltd.); QX11 and QX40 (manufactured by Mitsubishi Chemical Corporation); Thiokol LP-33, Thiokol LP-3, Thiokol LP-980, Thiokol LP-23, Thiokol LP-56, Thiokol LP-55, Thiokol LP-12, Thiokol LP-32, Thiokol LP-2, and Thiokol LP-31 (manufactured by Toray Industries, Inc.); ADEKA Hardener EH-317 (manufactured by ADEKA Corporation); MPM, EHMP, NOMP, MBMP, STMP, TMMP, TMPIC, PEMP, EGMP-4, and DPMP (manufactured by Sakai Chemical Industry Co., Ltd.); HDTG, TMTG, and PETG (manufactured by Yodo Kagaku Co., Ltd.).

The monomer containing a thiol group is preferably a compound containing a —O—CO—R—SH group (where R is a linear or branched alkylene group having 1 to 5 carbon atoms).

The liquid crystal layer 6 may contain, for example, a first compound having a structure represented by the following formula (1) for the purpose of increasing the elongation margin in the slow axis direction. The second liquid crystal layer 8 and the third liquid crystal layer may be the same as the liquid crystal layer 6.

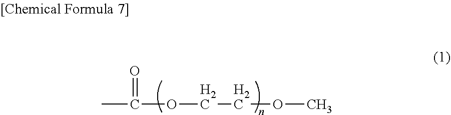

In the formula (1), n is 3 to 15. In the above formula (1), when n is 3 or more, it is possible to add a polyethylene glycol chain having excellent flexibility to the liquid crystal layer 6 and increase the elongation margin in the slow axis direction of the liquid crystal layer 6. In the formula (1), when n is 15 or less, the liquid crystal molecules of the liquid crystal layer 6 are easily aligned. In the above formula (1), n is preferably 4 to 13.

When the liquid crystal layer 6 contains the first compound, the liquid crystal composition contains, for example, a monofunctional monomer containing a polyethylene glycol chain. In the liquid crystal composition, a content C3 of the monofunctional monomer including a polyethylene glycol chain is, for example, 3% by mass to 30% by mass. When the content C3 is 3% by mass or more, occurrence of cracks in the liquid crystal layer 6 can be suppressed. When the content C3 is 30% by mass or less, the liquid crystal molecules of the liquid crystal layer 6 are easily aligned. The content C3 is preferably 4% by mass to 20% by mass.

The monofunctional monomer containing a polyethylene glycol chain is not particularly limited, and for example, a compound represented by the following formula (4) is used.

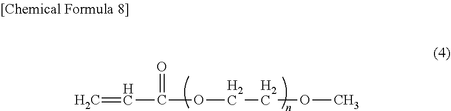

In the above formula (4), n is 3 to 15, preferably 4 to 13.

As described above, the monomer containing a polyethylene glycol chain is preferably monofunctional, and preferably is not bifunctional or polyfunctional. When the monomer including a polyethylene glycol chain is bifunctional or polyfunctional, the liquid crystal layer 6 includes a fifth compound having a structure represented by the following formula (5).

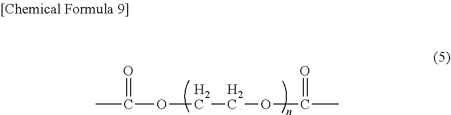

In the above formula (5), n is 3 to 15. In the structure represented by the formula (5), it is difficult to achieve both flexibility and alignment of the liquid crystal layer 6 as compared with the structure represented by the formula (1). When the flexibility of the liquid crystal layer 6 is intended to be secured, the alignment property becomes poor, and when the alignment property of the liquid crystal layer 6 is intended to be secured, the flexibility becomes insufficient.

In the liquid crystal layer 6, the concentration C1 of sulfur element may be 0.6% by mass to 3.5% by mass, the liquid crystal layer 6 may include the first compound, and n in the formula (1) may be 3 to 15. The sulfur element imparts flexibility to a crosslinking point of a compound constituting the liquid crystal layer. The structure represented by the formula (1) imparts flexibility to the side chain of the compound constituting the liquid crystal layer. When two types of flexibility are given to the liquid crystal layer as described above, the liquid crystal layer is easily deformed by stress and has high followability to a complex shape, which is preferable.

The retardation plate 3 has a tensile elongation C of 12% or more when a tensile test for pulling the retardation plate 3 in a predetermined direction is performed at a glass-transition temperature Tg_f of the transparent substrate 4 before being bonded to the three-dimensional structure 2. The tensile elongation C is defined by an equation of C=(B−A)/A×100. Here, A is the initial size of the retardation plate 3 in the predetermined direction, and B is the size of the retardation plate 3 in the predetermined direction when a crack penetrates the liquid crystal layer 6 occurs over a length 1 mm or more on the surface of the liquid crystal layer 6.

The direction in which the retardation plate 3 is pulled is, for example, a direction along the slow axis of the liquid crystal layer 6. As illustrated in FIG. 6, the conventional liquid crystal layer 106 has a small elongation margin in the slow axis direction, and a linear crack 107 may occur in a direction (fast axis direction) perpendicular to the slow axis direction. Whether or not the crack 107 occurs can be determined by pulling the retardation plate 3 in a direction along the slow axis of the liquid crystal layer 6. Although it is conceivable for the retardation plate 3 to be radially and uniformly pulled, it may be simply pulled in a direction along the slow axis.

When the tensile elongation C is 12% or more, the liquid crystal layer 6 is flexible, and for example, as illustrated in FIG. 4, even when the retardation plate 3 is bent to be bonded to the three-dimensional structure 2, cracks do not appreciably occur in the liquid crystal layer 6. The tensile elongation C is preferably 13% or more, more preferably 14% or more. The liquid crystal layer 6 may not be cracked until the transparent substrate 4 is broken by the tensile stress. That is, the tensile elongation C may exceed the measurement limit of the tensile test.

In the case where the retardation plate 3 includes the second liquid crystal layer 8, the tensile elongation C is preferably 12% or more even when a tensile test in which the retardation plate 3 is pulled in the slow axis direction of the second liquid crystal layer 8 is performed. Similarly, in the case where the retardation plate 3 includes the third liquid crystal layer, the tensile elongation C is preferably 12% or more also when a tensile test in which the retardation plate 3 is pulled in the slow axis direction of the third liquid crystal layer is performed.

The purpose of bending the retardation plate 3 is not limited to bonding the retardation plate 3 to the three-dimensional structure 2. The retardation plate 3 may be bonded to a curved surface of an object other than the three-dimensional structure 2.

In the optical element 1, a change in the number of cracks is one or less after versus before the high-temperature and high-humidity test, in which the optical element 1 is stored for 500 hours at a temperature of 65° C. and a relative humidity of 90%. The crack penetrates the liquid crystal layer 6 in the thickness direction and is formed on the surface of the liquid crystal layer 6 over a length of 1 mm or more. When the change in the number of cracks after versus before the high-temperature and high-humidity test is one or less, the quality of the optical element 1 can be maintained over a long period of time under an environment of normal temperature and normal humidity, and the quality of the optical element 1 is good. The change in the number of cracks after versus before the high-temperature and high-humidity test is preferably 0.

A retardation plate according to a first embodiment of the present disclosure includes a transparent substrate and a liquid crystal layer formed over the transparent substrate. A tensile elongation C defined by an equation C=(B−A)/A×100 is 12% or more, where A is an initial size of the retardation plate in a predetermined direction, and B is a size of the retardation plate in the predetermined direction when a crack penetrating the liquid crystal layer in a thickness direction occurs over a length of 1 mm or more on a surface of the liquid crystal layer.

According to the first embodiment of the present disclosure, by using a retardation plate having a tensile elongation C of 12% or more, occurrence of cracks particularly during bending of the retardation plate can be suppressed.

An optical element according to a second embodiment of the present disclosure includes a three-dimensional structure having a curved surface, and a retardation plate curved along the curved surface. The retardation plate includes a liquid crystal layer containing a compound having liquid crystallinity. The concentration of the sulfur element contained in the liquid crystal layer is 0.6% by mass to 3.5% by mass.

According to the second embodiment of the present disclosure, by using the liquid crystal layer in which the content of the sulfur element is 0.6% by mass or more, occurrence of cracks particularly during storage under high-temperature and high-humidity can be suppressed.

An optical element according to a third embodiment of the present disclosure includes a three-dimensional structure having a curved surface and a retardation plate curved along the curved surface. The retardation plate includes a liquid crystal layer containing a compound having liquid crystallinity. The liquid crystal layer contains a compound having a structure represented by the formula (1), and in the formula (1), n is 3 to 15.

According to the third embodiment of the present disclosure, by using the liquid crystal layer in which n in the formula (1) is 3 to 15, occurrence of cracks particularly during storage under high-temperature and high-humidity can be suppressed.

### EXAMPLES

Hereinafter, experimental data will be described.

### Materials

The materials used in the experiment were as follows:
Liquid crystal A1: product name “LC242” manufactured by BASF
Monomer B1: product name “C6FMA” Perfluorohexylethyl methacrylate, manufactured by AGC Inc.
Monomer B2: product name “NK ester A-DCP”, manufactured by SHIN-NAKAMURA CHEMICAL CO., LTD.
Monomer B3: product name “NK ester A-HD-N”, manufactured by SHIN-NAKAMURA CHEMICAL CO., LTD
Monomer B4: product name “U-6LPA”, manufactured by SHIN-NAKAMURA CHEMICAL CO, LTD.
Monomer B5: “Karenz MT BD01”, manufactured by Showa Denko Corporation
Monomer B6: product name “NK ester AM230G” (including formula (1), n=23), manufactured by SHIN-NAKAMURA CHEMICAL CO., LTD.
Monomer B7: product name “diethylene glycol monomethyl ether methacrylate” (including formula (1), n=2), manufactured by Tokyo Chemical Industry Co., Ltd.
Monomer B8: product name “NK ester AM30G” (including formula (1), n=3), manufactured by SHIN-NAKAMURA CHEMICAL CO., LTD.
Monomer B9: product name “NK ester AM90G” (including formula (1), n=9), manufactured by SHIN-NAKAMURA CHEMICAL CO., LTD.
Monomer B10: product name “NK ester AM130G” (including formula (1), n=13), manufactured by SHIN-NAKAMURA CHEMICAL CO., LTD.
Monomer B11: product name “NK ester A-200” (including formula (5), n=4), manufactured by SHIN-NAKAMURA CHEMICAL CO., LTD.

Surfactant C1: product name “SurflonS-651”, manufactured by AGC SEIMI CHEMICAL CO., LTD
D1: product name “IRGACURE907”, manufactured by Ciba Specialty Chemicals
Solvent E1: cyclopentanone
Transparent substrate F1: TAC film (ZRD4OSL 40 μm thick, manufactured by FUJIFILM Holding Corporation)
Transparent substrate F2: PMMA film (OXIS FZ-T13-W1-40, manufactured by Okura Industrial Cop., Ltd.)

### Photocurable Composition G1

10 g of the monomer B1, 35 g of the monomer B2, 31 g of the monomer B3, 20 g of the monomer B4, 1 g of the surfactant C1, and 3.0 g of the photopolymerization initiator D1 were mixed to prepare a photocurable composition G1. The photocurable composition G1 was used to form an alignment layer.

### Liquid Crystal Compositions L1 to L12

The liquid crystal compositions L1 to L12 were prepared in the amount indicated in Table 1. The liquid crystal compositions L2 to L5 and L12 include the formula (2) in which the monomer B5 and the liquid crystal A1 react with each other, the formula (2) in which the monomer B5 and the monomer B10 react with each other, or the formula (3) in which the monomers B5 react with each other.

TABLE 1

| | Amount Contained [g] | | | | | | | | | | | |
|---|---|---|---|---|---|---|---|---|---|---|---|---|
| | Liquid | | | | | | | | | Photopolymerization | | |
| Liquid Crystal | Crystal | Monomer | | | | | | | Surfactant | initiator | Solvent | Total |
| Composition | A1 | B5 | B6 | B7 | B8 | B9 | B10 | B11 | C1 | D1 | E1 | [g] |
| L1 | 100 | | | | | | | | 0.5 | 2 | 300 | 402.5 |
| L2 | 80 | 20 | | | | | | | 0.5 | 2 | 300 | 402.5 |
| L3 | 85 | 15 | | | | | | | 0.5 | 2 | 300 | 402.5 |
| L4 | 97 | 3 | | | | | | | 0.5 | 2 | 300 | 402.5 |
| L5 | 99 | 1 | | | | | | | 0.5 | 2 | 300 | 402.5 |
| L6 | 97 | | 3 | | | | | | 0.5 | 2 | 300 | 402.5 |
| L7 | 60 | | | 40 | | | | | 0.5 | 2 | 300 | 402.5 |
| L8 | 80 | | | | 20 | | | | 0.5 | 2 | 300 | 402.5 |
| L9 | 85 | | | | | 15 | | | 0.5 | 2 | 300 | 402.5 |
| L10 | 95 | | | | | | 5 | | 0.5 | 2 | 300 | 402.5 |
| L11 | 85 | | | | | | | 15 | 0.5 | 2 | 300 | 402.5 |
| L12 | 92 | 3 | | | | | 5 | | 0.5 | 2 | 300 | 402.5 |

The liquid crystal compositions L1 to L12 were used for forming liquid crystal layers.

### Mold M

As a mold M, a resin mold LSP70-140 (pitch 140 nm height 150 nm) manufactured by Soken Chemical & Engineering Co., Ltd. was prepared.

### Retardation Plate and Optical Element

In the experimental examples 1 to 15 below, retardation plates were prepared using the photocurable composition G1, the mold M, and the liquid crystal compositions L1 to L12. In the experimental examples 1, 2, 4 to 7, and 9 to 15 except for the experimental examples 3 and 8, optical elements were prepared using the produced retardation plates. The experimental examples 4 to 6, 10 to 13, and 15 below are Examples, and the experimental examples 1 to 3, 7 to 9, and 14 are Comparative Examples.

### Experimental Example 1

The alignment layer was prepared by the following procedure. First, the photocurable composition G1 was interposed between the mold M and the transparent substrate F1, and the photocurable composition G1 was irradiated with ultraviolet rays of 1000 mJ/cm² through the transparent substrate F1 to cure the photocurable composition G1 in a state where the gap therebetween was maintained at 5 μm. Thereafter, the mold M was peeled off to produce a laminate composed of the alignment layer having irregularities formed thereon and the transparent substrate F1. A depth D of grooves in the alignment layer was 140 nm, and a pitch p was 140 nm. The depth D and the pitch p were measured by cross-sectional SEM observation. More specifically, each of D and p was measured at five points and determined as an average value thereof.

The liquid crystal layer was prepared by the following procedure. First, the liquid crystal composition L1 was applied to the uneven alignment layer by spin coating and dried at 90° C. for 5 minutes to form a liquid film having a thickness of 1 μm. The liquid film was irradiated with 1000 mJ/cm² ultraviolet rays in a nitrogen gas atmosphere to cure the liquid crystal composition L1. Thus, a retardation plate including the transparent substrate, the alignment layer, and the liquid crystal layer in this order was obtained.

The optical element was produced by the following procedure. First, a plano-concave lens (manufactured by Edmund Optics Inc., product code #45-038) was prepared as a three-dimensional structure. Next, an optically clear adhesive (PDS1 25 μm, manufactured by PANAC Corporation) was bonded as an adhesive layer to the surface of the transparent substrate. Thereafter, inside the vacuum container, the concave surface of the plano-concave lens was directed upward, and the retardation plate was disposed above the plano-concave lens. The retardation plate was horizontally disposed with the optically clear adhesive facing downward. Subsequently, the inside of the vacuum container was evacuated, the retardation plate was brought into contact with the concave surface of the plano-concave lens in a state where the retardation plate was heated to 145° C., and the retardation plate was pressed against the concave surface under an air pressure of 900 kPa to bend the retardation plate. Thereafter, a portion of the retardation plate protruding from the lens was cut off to obtain an optical element including the retardation plate and the three-dimensional structure.

### Experimental Example 2

In the experimental example 2, a retardation plate and an optical element were prepared in the same manner as in the experimental example 1 except that the transparent substrate F2 was used instead of the transparent substrate F1 and that the retardation plate was heated to 115° C. at the time of bonding the retardation plate and the three-dimensional structure.

### Experimental Example 3

In the experimental example 3, a retardation plate was prepared in the same manner as in the experimental example 1 except that the liquid crystal composition L2 was used instead of the liquid crystal composition L1, but the liquid crystal of the liquid crystal layer was not aligned. Therefore, an optical element was not prepared.

### Experimental Example 4

In the experimental example 4, a retardation plate and an optical element were prepared in the same manner as in the experimental example 1 except that the liquid crystal composition L3 was used instead of the liquid crystal composition L1.

### Experimental Example 5

In the experimental example 5, a retardation plate and an optical element were prepared in the same manner as in the experimental example 1 except that the liquid crystal composition L4 was used instead of the liquid crystal composition L1.

### Experimental Example 6

In the experimental example 6, a retardation plate and an optical element were prepared in the same manner as in the experimental example 1 except that the transparent substrate F2 was used instead of the transparent substrate F1, the liquid crystal composition L4 was used instead of the liquid crystal composition L1, and the retardation plate was heated to 115° C. at the time of bonding the retardation plate and the three-dimensional structure.

### Experimental Example 7

In the experimental example 7, a retardation plate and an optical element were prepared in the same manner as in the experimental example 1 except that the liquid crystal composition L5 was used instead of the liquid crystal composition L1.

### Experimental Example 8

In the experimental example 8, a retardation plate was prepared in the same manner as in the experimental example 1 except that the liquid crystal composition L6 was used instead of the liquid crystal composition L1, but the liquid crystal of the liquid crystal layer was not aligned. Therefore, an optical element was not prepared.

### Experimental Example 9

In the experimental example 9, a retardation plate and an optical element were prepared in the same manner as in the experimental example 1 except that the liquid crystal composition L7 was used instead of the liquid crystal composition L1.

### Experimental Example 10

In the experimental example 10, a retardation plate and an optical element were prepared in the same manner as in the experimental example 1 except that the liquid crystal composition L8 was used instead of the liquid crystal composition L1.

### Experimental Example 11

In the experimental example 11, a retardation plate and an optical element were prepared in the same manner as in the experimental example 1 except that the transparent substrate F2 was used instead of the transparent substrate F1, the liquid crystal composition L8 was used instead of the liquid crystal composition L1, and the retardation plate was heated to 115° C. at the time of bonding the retardation plate and the three-dimensional structure.

### Experimental Example 12

In the experimental example 12, a retardation plate and an optical element were prepared in the same manner as in the experimental example 1 except that the liquid crystal composition L9 was used instead of the liquid crystal composition L1.

### Experimental Example 13

In the experimental example 13, a retardation plate and an optical element were prepared in the same manner as in the experimental example 1 except that the liquid crystal composition L10 was used instead of the liquid crystal composition L1.

### Experimental Example 14

In the experimental example 14, a retardation plate and an optical element were prepared in the same manner as in the experimental example 1 except that the liquid crystal composition L11 was used instead of the liquid crystal composition L1.

### Experimental Example 15

In the experimental example 15, a retardation plate and an optical element were prepared in the same manner as in the experimental example 1 except that the liquid crystal composition L12 was used instead of the liquid crystal composition L1.

### Evaluation

### Sulfur Element Concentration

The concentration of the sulfur element in the liquid crystal layer was calculated from the amount contained in the liquid crystal composition. The results are indicated in Table 2. When the concentration of the sulfur element in the liquid crystal layer is measured after the liquid crystal composition is cured, for example, Auto Quick Furnace (AQF)-Ion Chromatography (IC) or the like can be used as a measuring device.

### n in Formula (1) or (5)

When the liquid crystal layer contains a compound having a structure represented by the above formula (1) or (5), n in the above formulae (1) and (5) was calculated from the structure of a monomer in the liquid crystal composition.

### Tensile Elongation

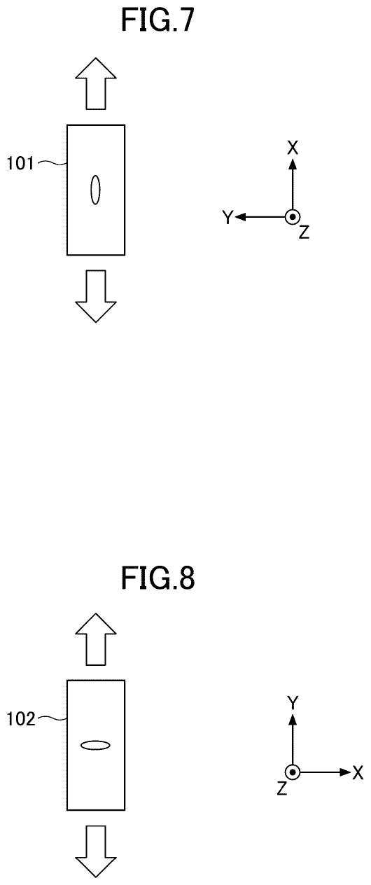

As test pieces of the tensile elongation C, a first test piece 101 illustrated in FIG. 7 and a second test piece 102 illustrated in FIG. 8 were prepared. The first test piece 101 was a test piece for measuring tensile elongation in the X-axis direction, and was a rectangular parallelepiped having a size of 80 mm in the X-axis direction and a size of 25 mm in the Y-axis direction. The second test piece 102 was a test piece for measuring the tensile elongation in the Y-axis direction, and was a rectangular parallelepiped having a size of 25 mm in the X-axis direction and a size of 80 mm in the Y-axis direction.

The sizes of the first test piece 101 and the second test piece 102 are not limited to the above. For example, in the case of a test piece for measuring the tensile elongation in the X-axis direction, the test piece may be a rectangular parallelepiped having a size of 15 mm in the X-axis direction and a size of 5 mm in the Y-axis direction. In the case of a test piece for measuring the tensile elongation in the Y-axis direction, the test piece may be a rectangular parallelepiped having a size of 5 mm in the X-axis direction and a size of 15 mm in the Y-axis direction.

As a tensile tester, a small table-top tester manufactured by Shimadzu Corporation was used. The chuck-to-chuck distance at the start of the test was set to 60 mm and the pulling rate was set to 10 mm/min. The heating temperature of each test piece was set to the glass-transition temperature of the transparent substrate. The glass-transition temperature of the transparent substrate F1 was 145° C., and the glass-transition temperature of the transparent substrate F2 was 115° C.

During the tensile test, of the surface of the liquid crystal layer (80 mm in the longitudinal direction and 25 mm in the width direction), the area in the center of the surface (40 mm in the longitudinal direction and 10 mm in the width direction) was visually observed. When cracks were found over a length of 1 mm or more on the surface of the liquid crystal layer, whether or not the cracks penetrated the liquid crystal layer in the thickness direction was further examined by cross-sectional SEM observation.

The measurement results of the tensile elongation are indicated in Table 2. In Table 2, the tensile elongation of “-” means that no crack occurred in the liquid crystal layer until the transparent substrate 4 was broken by the tensile stress. That is, in Table 2, “-” for the tensile elongation indicates that the tensile elongation exceeded the measurement limit of the tensile test.

### Bending Processability

The bending processability of the retardation plate was evaluated as good or bad by the following method. After the retardation plate was bonded to the concave surface of the plano-concave lens, before the high-temperature and high-humidity test to be described later, an area of the concave surface inward from the periphery of the concave surface by the 5 mm portion or more was observed by visual observation and cross-sectional SEM observation. The bending processability was determined to be good or bad by the presence or absence of cracks which penetrated the liquid crystal layer and were formed over a length of 1 mm or more on the surface of the liquid crystal layer. The results are indicated in Table 2. In Table 2, the bending processability of “A” means that there was no crack, and the bending processability of “B” means that there was a crack.

### High-Temperature and High-Humidity Test

In the high-temperature and high-humidity test, the optical element was stored in an environment at a temperature of 65° C. and a relative humidity of 90% for 500 hours, and the appearance of the optical element was observed. Before and after the high-temperature and high-humidity test, the number of cracks penetrating the liquid crystal layer and forming the length of 1 mm or more on the surface of the liquid crystal layer was counted. In Table 2, “N1” is the number of cracks before the high-temperature and high-humidity test, and “N2” is the number of cracks after the high-temperature and high-humidity test. The results are indicated in Table 2. In Table 2, the evaluation of “A” in the high-temperature and high-humidity test indicates that the change in the number of cracks was one or less, and the evaluation of “B” in the high-temperature and high-humidity test indicates that the change (increase) in the number of cracks was two or more.

TABLE 2

| | | | | Concen- | | | | | | | | | |
|---|---|---|---|---|---|---|---|---|---|---|---|---|---|
| | Transparent | | Liquid | tration | formula | formula | | Tensile | | Bending | High-Temperature and | | |
| | Substrate | | Crystal | of S | (1) | (5) | Crystal | Elongation [%] | | Process- | High-Humidity Test | | |
| | Type | Tg[° C.] | Composition | [% by mass] | n | n | Alignment | Slow Axis | Fast Axis | ability | N1 | N2 | Evaluation |
| Experimental | F1 | 145 | L1 | 0 | — | — | A | 10 | — | B | 10 | 15 | B |
| Example 1 | | | | | | | | | | | | | |
| Experimental | F2 | 115 | L1 | 0 | — | — | A | 10 | — | B | 12 | 15 | B |
| Example 2 | | | | | | | | | | | | | |
| Experimental | F1 | 145 | L2 | 4.2 | — | — | B | | | | | | |
| Example 3 | | | | | | | | | | | | | |
| Experimental | F1 | 145 | L3 | 3.2 | — | — | A | 18 | — | A | 0 | 0 | A |
| Example 4 | | | | | | | | | | | | | |
| Experimental | F1 | 145 | L4 | 0.6 | — | — | A | 12 | — | A | 0 | 0 | A |
| Example 5 | | | | | | | | | | | | | |
| Experimental | F2 | 115 | L4 | 0.6 | — | — | A | 12 | — | A | 0 | 0 | A |
| Example 6 | | | | | | | | | | | | | |
| Experimental | F1 | 145 | L5 | 0.2 | — | — | A | 10 | — | B | 8 | 10 | B |
| Example 7 | | | | | | | | | | | | | |
| Experimental | F1 | 145 | L6 | 0 | 23 | — | B | | | | | | |
| Example 8 | | | | | | | | | | | | | |
| Experimental | F1 | 145 | L7 | 0 | 2 | | A | 10 | | B | 9 | 13 | B |
| Example 9 | | | | | | | | | | | | | |
| Experimental | F1 | 145 | L8 | 0 | 3 | — | A | 13 | — | A | | | |
| Example 10 | | | | | | | | | | | | | |
| Experimental | F2 | 115 | L8 | 0 | 3 | — | A | 13 | — | A | 0 | 0 | A |
| Example 11 | | | | | | | | | | | | | |
| Experimental | F1 | 145 | L9 | 0 | 9 | — | A | 13 | — | A | 0 | 0 | A |
| Example 12 | | | | | | | | | | | | | |
| Experimental | F1 | 145 | L10 | 0 | 13 | — | A | 13 | — | A | 0 | 0 | A |
| Example 13 | | | | | | | | | | | | | |
| Experimental | F1 | 145 | L11 | 0 | — | 4 | A | 10 | — | B | | | |
| Example 14 | | | | | | | | | | | | | |
| Experimental | F1 | 145 | L12 | 0.6 | 13 | — | A | 13 | — | A | 0 | 0 | A |
| Example 15 | | | | | | | | | | | | | |

As is clear from Table 2, in the experimental examples 4 to 6, the concentration of the sulfur element (concentration of S) in the liquid crystal layer was 0.6% by mass to 3.5% by mass, the liquid crystal molecules of the liquid crystal layer were aligned, the tensile elongation in the slow axis direction was 12% or more, the bending processability was good, and the evaluation in the high-temperature high-humidity test was also good. On the other hand, in the experimental examples 1, 2, and 7, the concentration of the sulfur element (concentration of S) in the liquid crystal layer was less than 0.6% by mass, the tensile elongation in the slow axis direction was less than 12%, the bending processability was poor, and the evaluation in the high-temperature high-humidity test was also poor. In the experimental example 3, the concentration of the sulfur element (concentration of S) in the liquid crystal layer exceeded 3.5% by mass, and the liquid crystal molecules of the liquid crystal layer were not appreciably aligned.

In the experimental examples 10 to 13 and 15, the liquid crystal layer contained the first compound including the structure represented by the above formula (1), n in the formula (1) was 3 to 15, the liquid crystal molecules of the liquid crystal layer were aligned, the tensile elongation in the slow axis direction was 12% or more, the bending processability was good, and the evaluation in the high-temperature and high-humidity test was also good. On the other hand, in the experimental example 8, although the liquid crystal layer contained the first compound including the structure represented by the formula (1), n in the formula (1) exceeded 15, and the liquid crystal molecules of the liquid crystal layer were not appreciably aligned. In the experimental example 9, the liquid crystal layer contained the first compound including the structure represented by the formula (1), but n in the formula (1) was less than 3, the tensile elongation in the slow axis direction was less than 12%, and the bending processability was poor. In the experimental example 14, the liquid crystal layer contained the fifth compound including the structure represented by the formula (5) instead of the formula (1), and n in the formula (5) was 3 to 15. However, the tensile elongation in the slow axis direction was less than 12%, and the bending processability was poor.

Although the retardation plate and the optical element according to the present disclosure have been described above, the present disclosure is not limited to the above-described embodiments and the like. Various changes, modifications, substitutions, additions, deletions, and combinations are possible within the scope described in the claims. These also naturally fall within the technical scope of the present disclosure.

What is claimed is:

1. A retardation plate comprising:
a transparent substrate; and
a liquid crystal layer formed over the transparent substrate,
wherein, when a tensile test is performed by pulling the retardation plate in a predetermined direction at a glass-transition temperature of the transparent substrate, a tensile elongation C defined by an equation of C=(B−A)/A×100 is 12% or more,
where A is an initial size of the retardation plate in the predetermined direction, and B is a size of the retardation plate in the predetermined direction when a crack penetrating the liquid crystal layer in a thickness direction occurs over a length of 1 mm or more on a surface of the liquid crystal layer.

2. The retardation plate according to claim 1, wherein the liquid crystal layer has a slow axis and a fast axis, and wherein the predetermined direction is a direction along the slow axis of the liquid crystal layer.

3. The retardation plate according to claim 1, wherein a concentration of a sulfur element in the liquid crystal layer is 0.6% by mass to 3.5% by mass.

4. The retardation plate according to claim 1, wherein the liquid crystal layer contains a compound having a structure represented by a following formula (1), and n in the following formula (1) is 3 to 15.

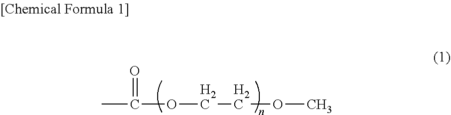

5. The retardation plate according to claim 1, wherein a concentration of a sulfur element in the liquid crystal layer is 0.6% by mass to 3.5% by mass, the liquid crystal layer contains a compound having a structure represented by a following formula (1), and n in the following formula (1) is 3 to 15.

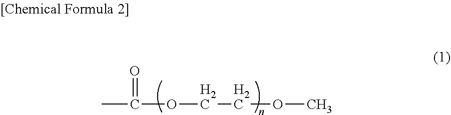

6. The retardation plate according to claim 2, further comprising a second liquid crystal layer over the transparent substrate, wherein the second liquid crystal layer includes a slow axis in a direction different from a direction of the slow axis of the liquid crystal layer.

7. The retardation plate according to claim 1, wherein when the glass-transition temperature (° C.) of the transparent substrate is defined as Tg, the transparent substrate is bent while being heated at a temperature of Tg−10° C. or higher and Tg+30° C. or lower.

8. An optical element comprising:
a three-dimensional structure having a curved surface; and
a retardation plate curved along the curved surface of the three-dimensional structure,
wherein the retardation plate includes a liquid crystal layer containing a compound having liquid crystallinity, and
wherein a concentration of a sulfur element in the liquid crystal layer is 0.6% by mass to 3.5% by mass.

9. The optical element according to claim 8, wherein the liquid crystal layer contains the compound having a structure represented by a following formula (1), and n in the following formula (1) is 3 to 15.

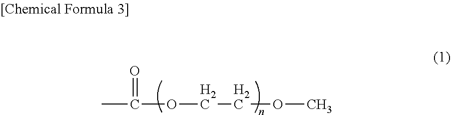

10. An optical element comprising:
a three-dimensional structure having a curved surface; and
a retardation plate curved along the curved surface of the three-dimensional structure,
wherein the retardation plate includes a liquid crystal layer containing a compound having liquid crystallinity, and
wherein the liquid crystal layer contains the compound having a structure represented by a following formula (1), and n in the following formula (1) is 3 to 15.

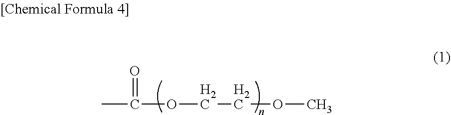

11. The optical element according to claim 8, wherein a change in a number of cracks that penetrate the liquid crystal layer in a thickness direction and that are formed over a length of 1 mm or more on a surface of the liquid crystal layer, after versus before a high-temperature and high-humidity test in which the optical element is stored in an environment of 65° C. and 90% of relative humidity for 500 hours, is one or less.

12. The optical element according to claim 8, wherein the curved surface of the three-dimensional structure has a curvature radius of 10 mm to 100 mm over an entire surface of the curved surface or a part of the curved surface.

13. The optical element according to claim 8, wherein the retardation plate includes a second liquid crystal layer having a slow axis in a direction different from a direction of the slow axis of the liquid crystal layer.
